(19) United States
(12) Patent Application Publication
(10) Pub. No.: US 2015/0322715 A1
(43) Pub. Date: Nov. 12, 2015

(54) RAINBOW BLIND STRUCTURE

(71) Applicant: Tser Wen CHOU, Taipei City (TW)

(72) Inventor: Tser Wen CHOU, Taipei City (TW)

(21) Appl. No.: 14/693,849

(22) Filed: Apr. 22, 2015

(30) Foreign Application Priority Data
May 12, 2014 (TW) 103208255

(51) Int. Cl. E06B 9/42; E06B 9/78

(52) U.S. Cl. CPC E06B 9/42; E06B 9/78

(57) ABSTRACT

A rainbow blind structure includes a drive shaft, two sleeves, two side caps, a lower weight and a locating plate. The drive shaft is connected with the side caps via the sleeves and rollable. The side caps are connected with the lower weight by means of screws. The rainbow blind sheet is wound over the drive shaft. When a blind sheet winder is operated to wind or unwind the blind sheet, the drive shaft is driven to move up and down, whereby the lower weight is moved up and down with the drive shaft. The weight of the lower weight can keep the blind sheet plane and tidy. The lower weight is formed with a locating slot. When a blind sheet is affixed to the lower weight to enclose the same, the locating plate is inserted in the locating slot to locate the blind sheet around the lower weight.

### BACKGROUND OF THE INVENTION

1. Field of the Invention

The present invention relates generally to a rainbow blind, and more particularly to rainbow blind structure, which can be operated with less strength and has a beautified appearance.

2. Description of the Related Art

A conventional rainbow blind generally has a lower weight, a shaft and side caps. The shaft generally is a polished iron rod. The rainbow blind sheet is wound over the bottom of the polished iron rod to drive the same. However, the frictional force between the polished face and the blind sheet is quite small so that the blind sheet can hardly effectively drive the iron rod. Moreover, the lower weight is often swung by excessively large amplitude. This will affect the operation effect and the planarity of the blind sheet.

Furthermore, the lower weight of the conventional rainbow blind is made of plastic material. After the entire rainbow blind assembly is completed, the appearance of the lower weight will be different from that of the blind sheet. This leads to poor appearance of the rainbow blind as a whole.

### SUMMARY OF THE INVENTION

It is therefore a primary object of the present invention to provide a rainbow blind having a drive shaft. The outer circumference of the drive shaft is formed with splines for increasing the frictional force between the rainbow blind sheet and the drive shaft. Accordingly, the rainbow blind sheet can be wound over the drive shaft to more effectively drive the same. When winding or unwinding the blind sheet, the drive shaft and the lower weight are driven to together move up and down. The weight of the lower weight can keep the blind sheet plane and tidy. In addition, the lower weight is formed with a locating slot. A locating plate is inserted in the locating slot to fix the blind sheet enclosing the lower weight. In this case, the appearance of the lower weight and the appearance of the blind sheet can be unified to enhance the beauty of the rainbow blind as a whole.

To achieve the above and other objects, the rainbow blind structure of the present invention includes: a drive shaft, multiple splines being formed on outer circumference of the drive shaft, the drive shaft being formed with an axial passage; two sleeves connected to two sides of the drive shaft, each of the two sleeves having a disc and a stem section protruding from one side of the disc, the stem sections being fitted in the passages of the drive shaft, the other side of the disc being formed with a through hole; two side caps, each of the two side caps having a protruding column at upper end for fitting into the through hole of the sleeve, the side cap further having an insertion block protruding from lower end for inserting with a lower weight; a lower weight, two wall sections upward extending from upper side of the lower weight to define a space for receiving the drive shaft therein, bottom sections of the wall sections defining a locating slot, a lower side of the lower weight being formed with a passageway in which the insertion blocks of the side caps are inserted; and a locating plate made of soft material, the locating plate being inserted in the locating slot of the bottom sections of the wall sections of the lower weight for locating and covering a blind sheet around outer circumference of the lower weight.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective view showing that a blind sheet is adhered to the lower weight of the present invention;

FIG. 3 is a perspective view showing that lower weight of the present invention is covered by the blind sheet;

FIG. 4 is a sectional view showing that lower weight of the present invention is covered by the blind sheet;

FIG. 5 is a perspective assembled view of the lower weight of the present invention;

FIG. 6 is a sectional assembled view of the lower weight of the present invention;

FIG. 7 is a perspective view showing that the installation of the invention is completed;

FIG. 8 is a side view showing the use of the present invention;

FIG. 9 is a perspective exploded view of the present invention, showing another embodiment of the drive shaft thereof;

FIG. 10 is a perspective exploded view of the present invention, showing still another embodiment of the drive shaft thereof;

FIG. 11 is a perspective exploded view of the present invention, showing another embodiment of the lower weight thereof;

FIG. 12 is a sectional assembled view of the present invention, showing the other embodiment of the lower weight thereof;

FIG. 13 is a perspective exploded view of another embodiment of the present invention; and

FIG. 14 is a sectional assembled view of the other embodiment of the present invention.

### DETAILED DESCRIPTION OF THE PREFERRED EMBODIMENTS

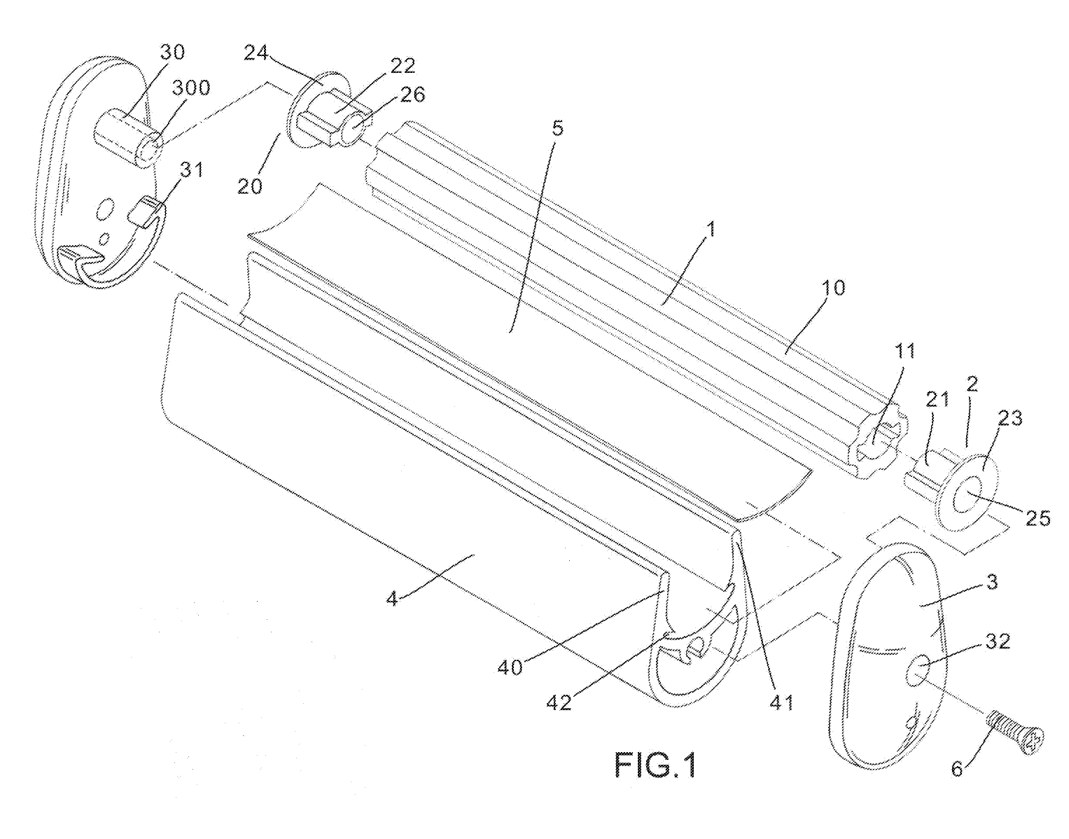

Please refer to FIG. 1. The present invention includes a drive shaft 1, two sleeves 2, 20, two side caps 3, a lower weight 4 and a locating plate 5. Multiple splines 10 are formed on outer circumference of the drive shaft 1. The drive shaft 1 is formed with a central axial passage 11. Each of the two sleeves 2, 20 has a stem section 21, 22 on one side. The stem sections 21, 22 have identical shapes and are directly fitted in the passages 11 of the drive shaft 1. A disc 23, 24 is disposed at one end of the stem section 21, 22 of the sleeves 2, 20. The disc 23, 24 is formed with a through hole 25, 26 extending from the disc 23, 24 to outer end of the stem sections 21, 22. Each of the two side caps 3 has a protruding circular rod 30. The circular rods 30 are received in the through holes 25, 26. Accordingly, the drive shaft 1 can be rotatably located between the two side caps 3. A metal rod 300 is enclosed in the circular rod 30 to reinforce the circular rod 30. An insertion block 31 is disposed at bottom end of the side cap 3 for engaging with the lower weight 4. The center of the side cap 3 is formed with a perforation 32. A fastening screw 6 is passed through the perforation 32 to integrally connect the side cap 3 with the lower weight 4. Wall sections 40, 41 upward extend from upper side of the lower weight 4 to define a space for receiving the drive shaft 1 therein. A locating slot 42 is formed on the bottom of the space for inserting the locating plate 5 therein. The locating plate 5 is made of a soft material and can be inserted into the locating slot of the lower weight 4.

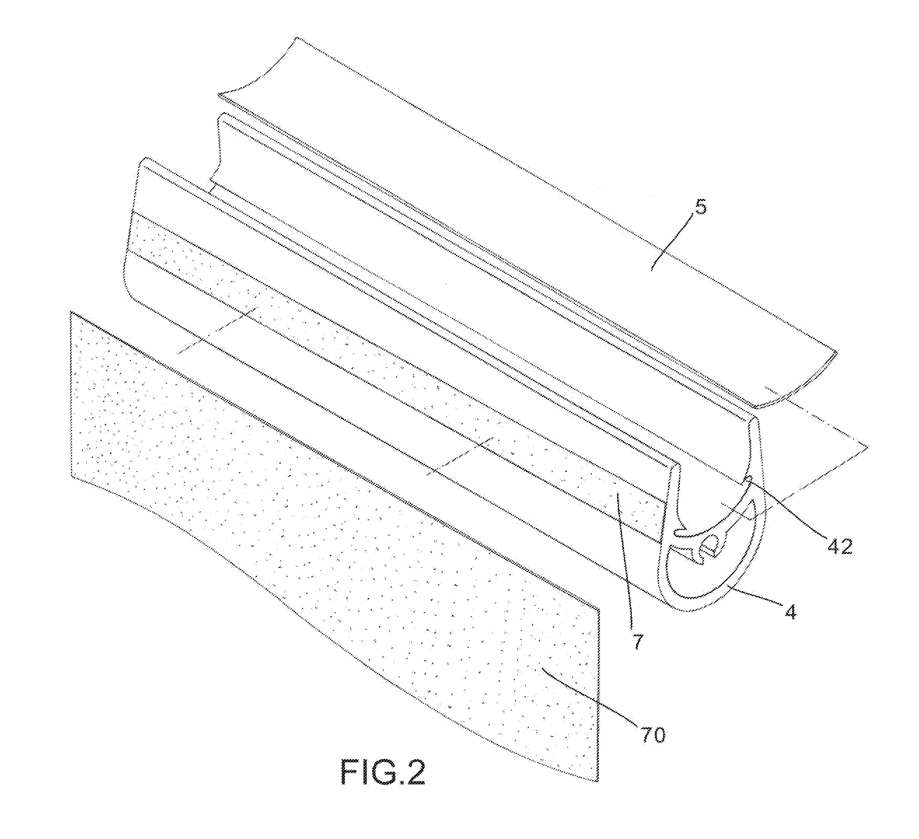

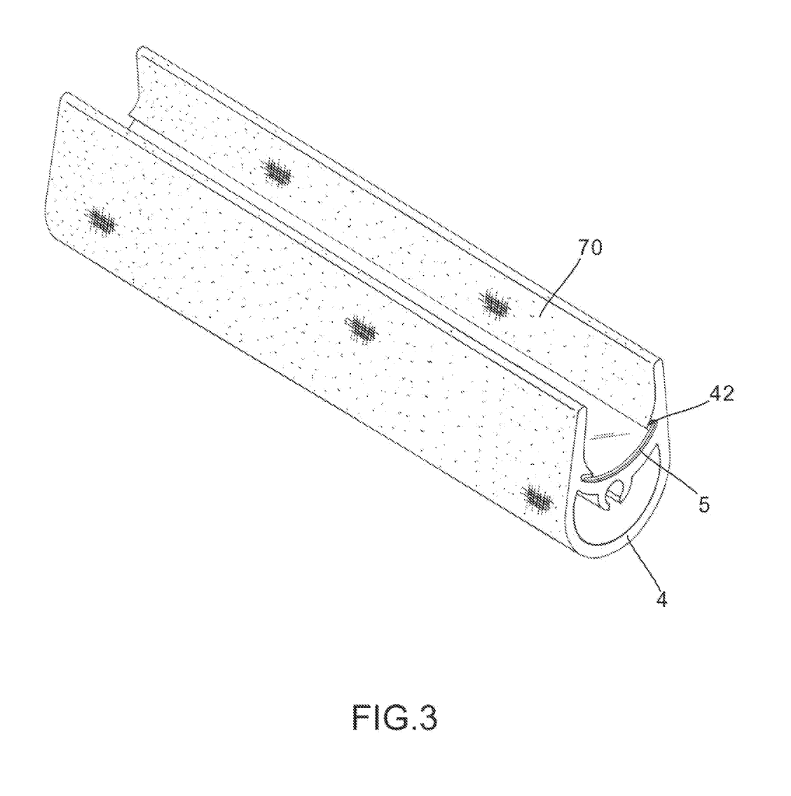

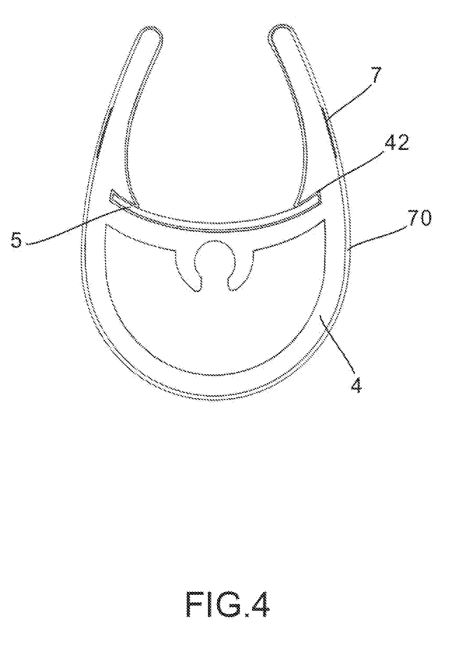

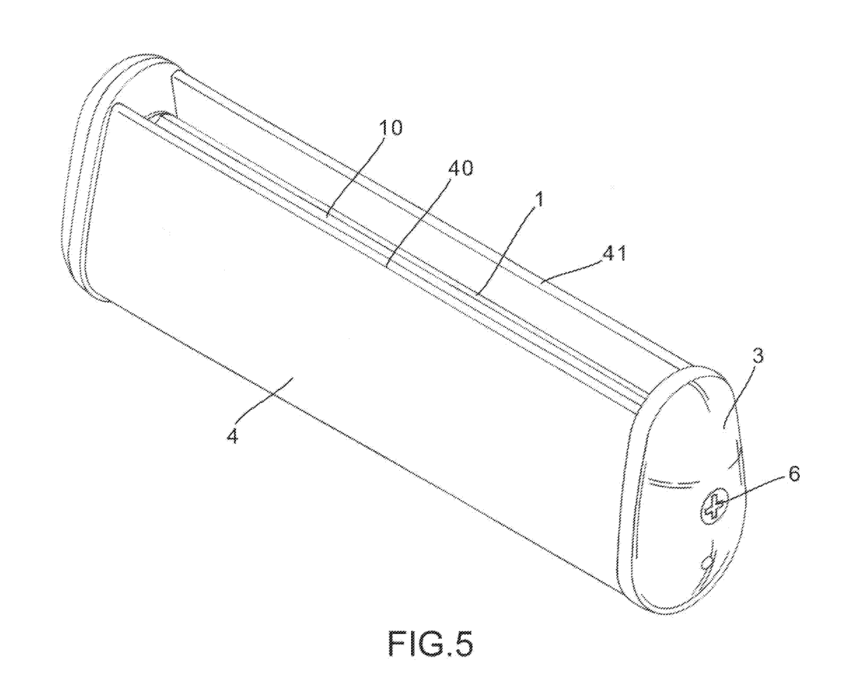

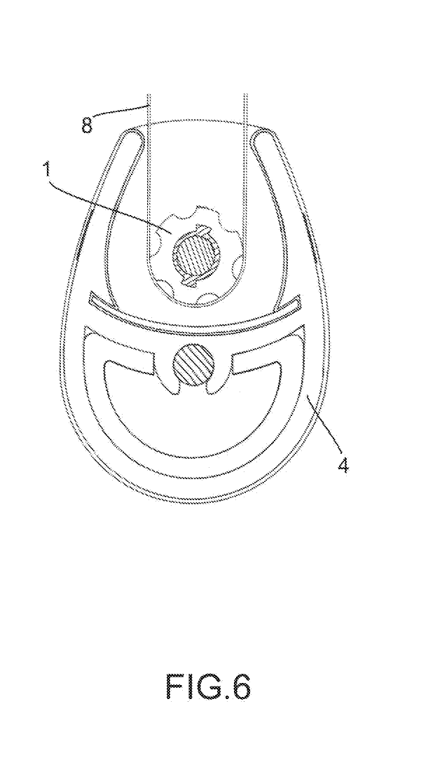

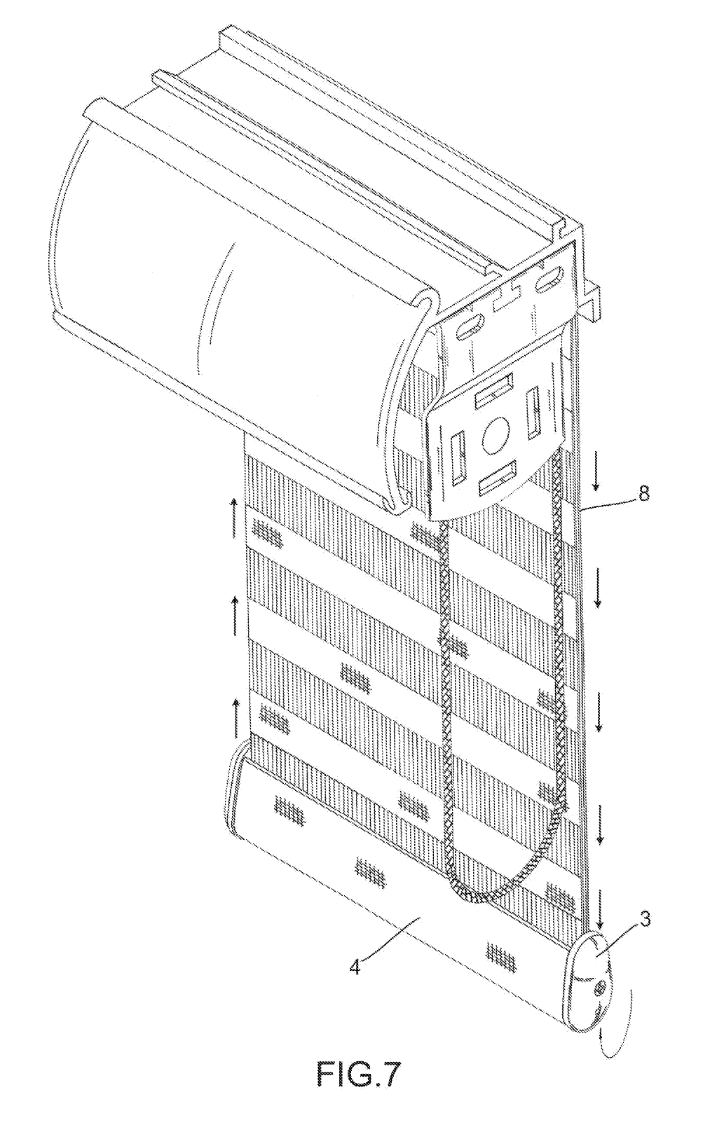

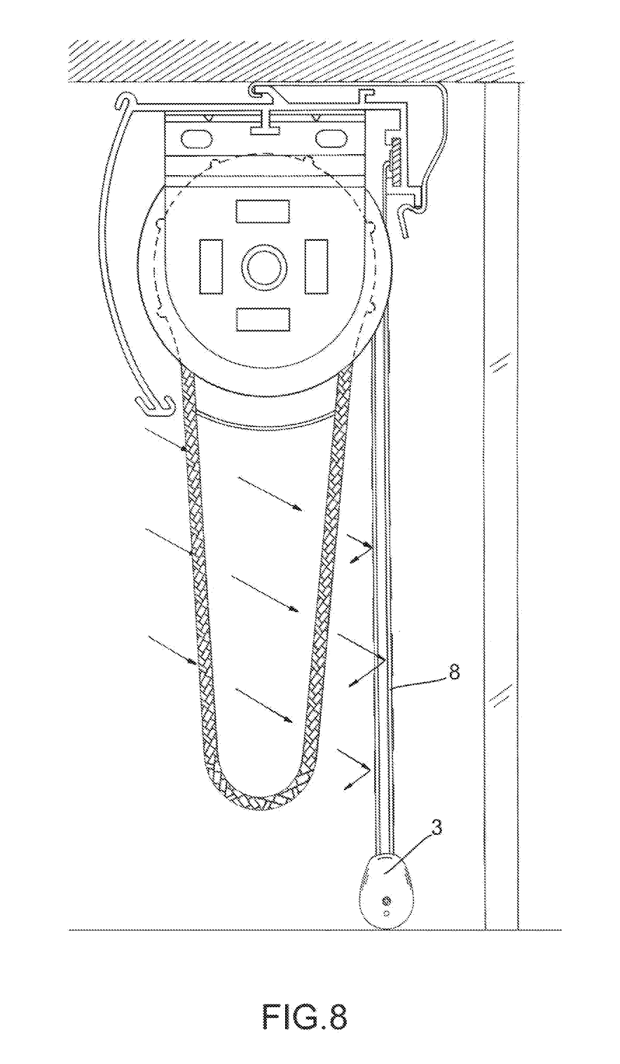

As shown in FIG. 2, when assembled, the blind sheet 70 is first affixed to outer faces of the lower weight by means of double-faced adhesive tapes 7 to cover the lower weight. Thereafter, the locating plate 5 is inserted into the locating slot 42 to fully cover and fix the blind sheet 70 (as shown in FIGS. 3 and 4). Then, the two side caps 3 are locked on two sides of the lower weight 4 by means of the fastening screws 6, whereby the drive shaft 1 is disposed between the two wall sections 40, 41 on upper side of the lower weight to complete the entire structure of the lower weight (as shown in FIG. 5). Then, a rainbow blind sheet 8 is wound over the drive shaft 1 (as shown in FIG. 6) to complete the assembly of the entire rainbow blind for shading the sunlight from the window (as shown in FIG. 7). When operating the blind sheet to move up and down (as shown in FIGS. 7 and 8), the transparent sections and nontransparent sections of the front and rear blind sheets are alternately positioned to achieve sunshade effect (as shown in FIG. 8).

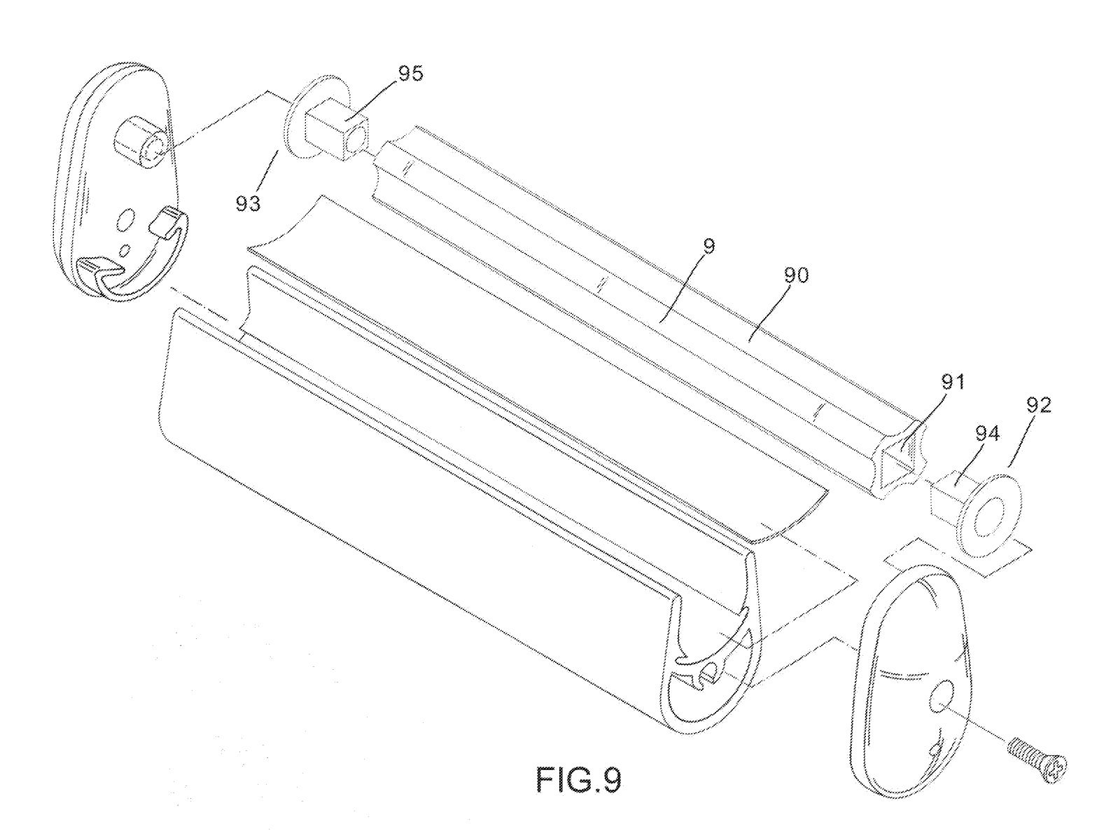

Please now refer to FIG. 9, which shows another embodiment of the drive shaft 9 of the present invention. Multiple flutes 90 are formed on outer circumference of the drive shaft 90. The center of the drive shaft 9 is formed with a longitudinal square passage 91. The stem sections 94, 95 of the sleeves 92, 93 also have a square form in adaptation to the square passage 91. The stem sections 94, 95 are snugly fitted in the square passage 91 to integrally connect the sleeves 92 with the drive shaft 9, whereby the drive shaft 9 is rollable.

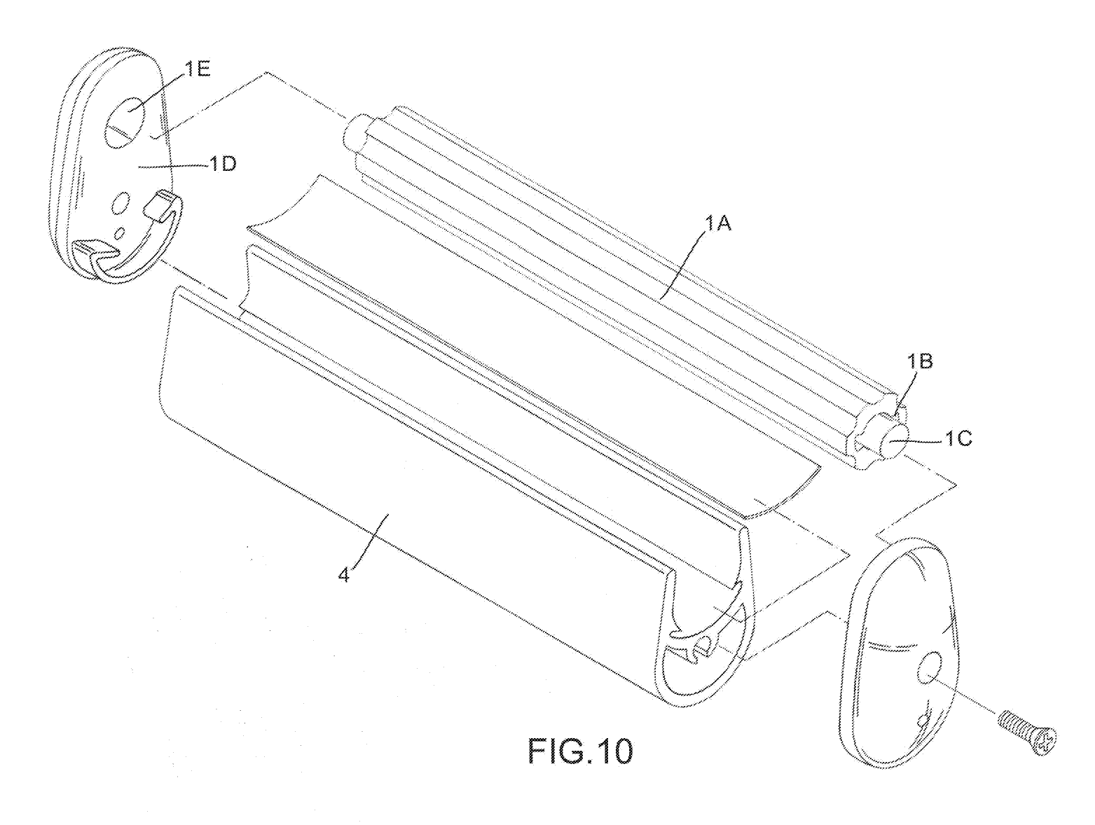

Please now refer to FIG. 10, which shows still another embodiment of the drive shaft 1A of the present invention. A roller shaft 1C is fitted through the central passage 1B of the drive shaft 1A. Two ends of the roller shaft 1C are rotatably fitted in the sockets 1E of the side caps 1D. Accordingly, the rainbow blind sheet can be wound over the drive shaft 1A to drive the lower weight to move up and down.

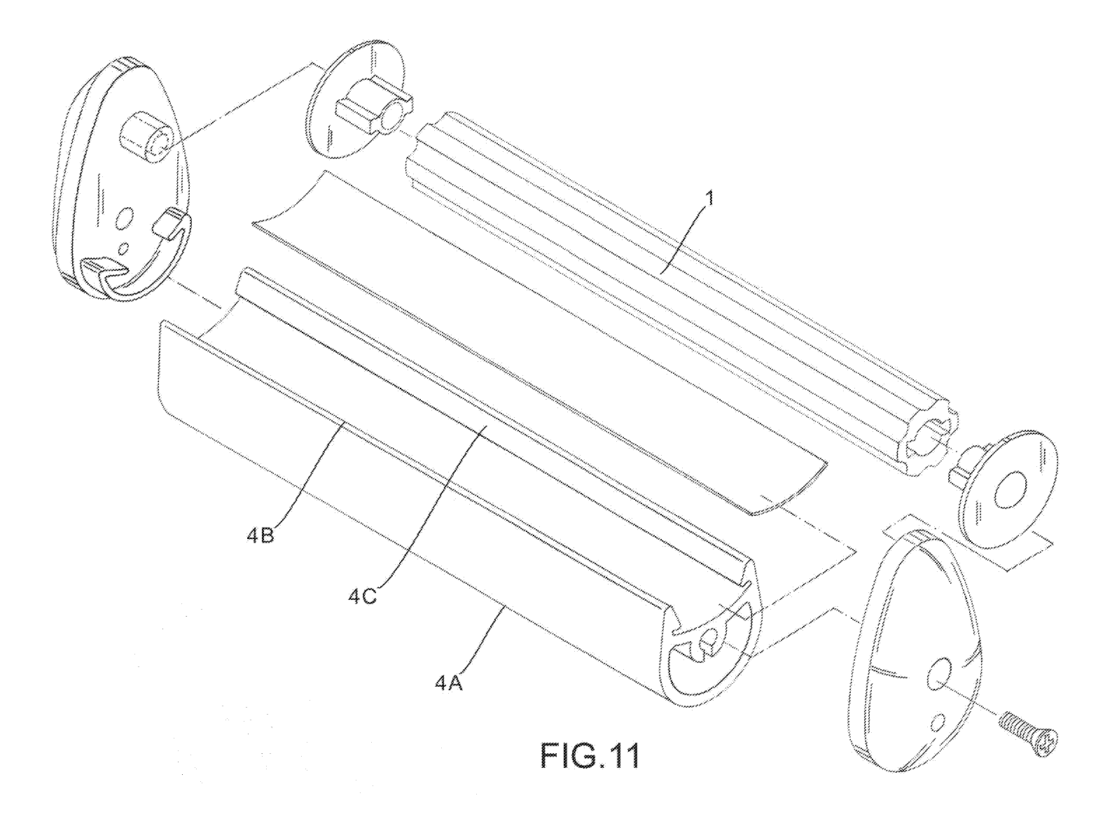

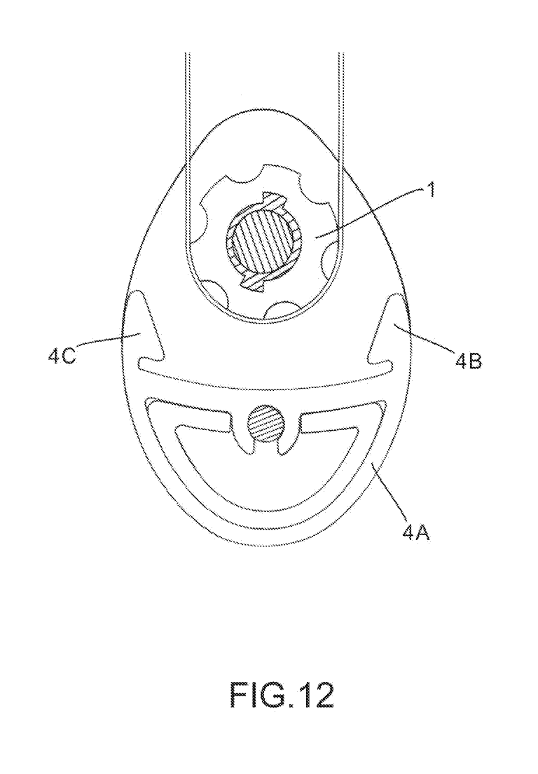

Please now refer to FIG. 11, which shows another embodiment of the lower weight of the present invention. The wall sections 4B, 4C extend from the upper side of the main body of the lower weight 4A by a shorter length. The drive shaft 1 is rotatably positioned on the upper sides of the wall sections without being enclosed by the wall sections 4B, 4C (as shown in FIG. 12).

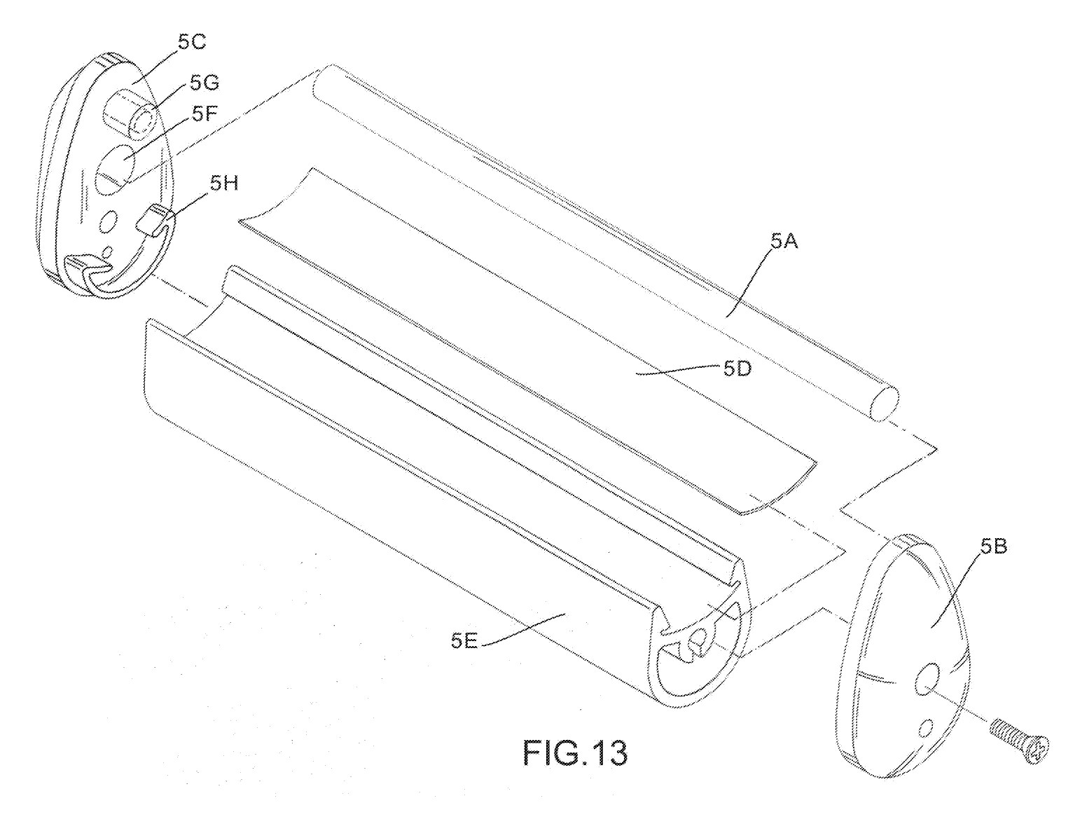

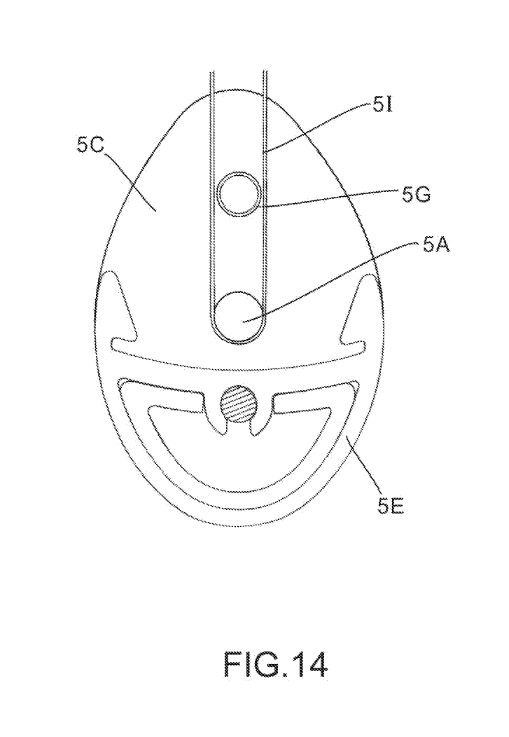

Please now refer to FIGS. 13 and 14, which show another embodiment of the present invention. This embodiment of the present invention includes a drive shaft 5A, two side caps 5B, 5C, a locating plate 5D and a lower weight 5E. The drive shaft 5A is a circular rod rotatably fitted in the sockets 5F of the two side caps 5B, 5C. Restriction columns 5G are disposed at upper ends of the side caps 5B, 5C. Protruding insertion blocks 5H are disposed at lower ends of the side caps 5B, 5C for inserting with the lower weight 5E. The above components are assembled to form a lower weight structure. The rainbow blind sheet 51 is wound over the lower side of the circular drive shaft 5A to drive the lower weight to move up and down. At this time, the restriction columns 5G restrict the lower weight from displacing left or right and keep the lower weight vertically moving up and down (as shown in FIG. 14).

The above embodiments are only used to illustrate the present invention, not intended to limit the scope thereof. Many modifications of the above embodiments can be made without departing from the spirit of the present invention.

What is claimed is:

1. A rainbow blind structure comprising:
a drive shaft, multiple splines being formed on outer circumference of the drive shaft, the drive shaft being formed with an axial passage;
two sleeves connected to two sides of the drive shaft, each of the two sleeves having a disc and a stem section protruding from one side of the disc, the stem sections being fitted in the passages of the drive shaft, the other side of the disc being formed with a through hole;
two side caps, each of the two side caps having a protruding column at upper end for fitting into the through hole of the sleeve, the side cap further having an insertion block protruding from lower end for inserting with a lower weight;
a lower weight, two wall sections upward extending from upper side of the lower weight to define a space for receiving the drive shaft therein, bottom sections of the wall sections defining a locating slot, a lower side of the lower weight being formed with a passageway in which the insertion blocks of the side caps are inserted; and
a locating plate made of soft material, the locating plate being inserted in the locating slot of the lower weight for locating and covering a blind sheet around outer circumference of the lower weight.

2. The rainbow blind structure as claimed in claim 1, wherein the number of the splines is four, six or eight.

3. The rainbow blind structure as claimed in claim 1, wherein a metal rod is enclosed in the protruding column of the side cap.

4. A rainbow blind structure comprising:
a drive shaft, which is a circular rod body;
two side caps, a center of each of the two side caps being formed with a socket in which the drive shaft is fitted, a restriction column protruding from an upper side of the socket, an insertion block protruding from a lower side of the socket for inserting with a lower weight;
a lower weight, two wall sections upward extending from upper side of the lower weight to define a space for receiving the drive shaft therein, bottom sections of the wall sections defining a locating slot, a lower side of the lower weight being formed with a passageway in which the insertion blocks of the side caps are inserted; and
a locating plate made of soft material, the locating plate being inserted in the locating slot of the lower weight for locating and covering a blind sheet around outer circumference of the lower weight

5. The rainbow blind structure as claimed in claim 4, wherein the restriction column of the side cap is slightly smaller than the drive shaft.
